(19) United States
(12) Patent Application Publication
(10) Pub. No.: US 2012/0306833 A1
(43) Pub. Date: Dec. 6, 2012

(54) DISPLAY DEVICE AND DRIVING METHOD THEREOF

(76) Inventors: Yun-Chung Lin, Hsin-Chu (TW); Chung-Lung Li, Hsin-Chu (TW); Meng-Che Tsai, Hsin-Chu (TW)

(21) Appl. No.: 13/323,799

(22) Filed: Dec. 12, 2011

(30) Foreign Application Priority Data
May 31, 2011 (TW) 100119104

(51) Int. Cl. G06F 3/038

(52) U.S. Cl. 345/208

(57) ABSTRACT

A method for driving a display panel includes in a first time slot of a polarity inversion period turning on a plurality of first pixels in a first row via a first scan line, and providing a common voltage with a first potential; in a second time slot of the polarity inversion period turning on a plurality of second pixels in the first row via a second scan line, and providing the common voltage with a second potential; in a third time slot of the polarity inversion period turning on a plurality of first pixels in a second row via a third scan line, and providing the common voltage with the second potential; and in a fourth time slot of the polarity inversion period turning on a plurality of second pixels in the second row via a fourth scan line, and providing the common voltage with the first potential.

### BACKGROUND OF THE INVENTION

1. Field of the Invention

The present invention relates to a method for driving a display panel, and more particularly, to a method for driving a display panel via an AC common voltage.

2. Description of the Prior Art

Please refer to FIG. 1. FIG. 1 is a diagram showing a display device 100 of the prior art. The display device 100 of the prior art comprises a display panel 110, a data driver 120, a scan driver 130, and a common voltage supply circuit 140. The display panel 100 comprises a plurality of pixels R, G, B arranged in a matrix form, a plurality of scan lines L, a plurality of data lines S, and a common electrode 112. The plurality of data lines S, the plurality of scan lines L, and the common electrode 112 are electrically connected to the plurality of pixels R, G, B, wherein two adjacent pixels are electrically connected to a same data line S. The data driver 120 is electrically connected to the plurality of data lines S for providing display voltages to the plurality of pixels R, G, B. The scan driver 130 is electrically connected to the plurality of scan lines L for turning on the pixels in sequence via the scan line L. The common voltage supply circuit 140 is for providing a DC common voltage to the common electrode 112. A gray level of each of the pixels R, G, B is determined by a difference between the display voltage and the common voltage. The above driving structure of the display device 100 is a half source driving structure.

In order to prevent a display problem caused by parasitic capacitance effects of the pixels, the prior art provides a method for driving the display panel. Please refer to FIG. 2 to FIG. 4. FIG. 2 is a diagram showing a polarity inversion mode of the display panel of FIG. 1. FIG. 3 is a diagram showing a pixel-driving structure of the display panel of FIG. 1. FIG. 4 is a diagram showing related signals of the display panel of FIG. 1. As shown in the figures, a polarity of a gray level signal of the pixel changes when each frame displayed by the display panel is updated. A “+” sign indicates the polarity of the gray level signal of the pixel is positive, and a “−” sign indicates the polarity of the gray level signal of the pixel is negative. For example, when displaying a first frame (or in a first polarity inversion period), the scan driver 130 sequentially turns on a plurality of first pixels P11 in a first row via a first scan line L1 in a first time slot t1, turns on a plurality of second pixels P12 in the first row via a second scan line L2 in a second time slot t2, turns on a plurality of first pixels P21 in a second row via a third scan line L3 in a third time slot t3, turns on a plurality of second pixels P22 in the second row via a fourth scan line L4 in a fourth time slot t4, and so on. The polarity of the gray level signals of the plurality of first pixels P11 in the first row is positive, the polarity of the gray level signals of the plurality of second pixels P12 in the first row is negative, the polarity of the gray level signals of the plurality of first pixels P21 in the second row is negative, the polarity of the gray level signals of the plurality of second pixels P22 in the second row is positive, and so on. When displaying a second frame (or in a second polarity inversion period), the scan driver 130 sequentially turns on the plurality of first pixels P11 in the first row via the first scan line L1 in the first time slot t1, turns on the plurality of second pixels P12 in the first row via the second scan line L2 in the second time slot t2, turns on the plurality of first pixels P21 in the second row via the third scan line L3 in the third time slot t3, turns on the plurality of second pixels P22 in the second row via the fourth scan line L4 in the fourth time slot t4, and so on. The polarity of the gray level signals of the plurality of first pixels P11 in the first row is negative, the polarity of the gray level signals of the plurality of second pixels P12 in the first row is positive, the polarity of the gray level signals of the plurality of first pixels P21 in the second row is positive, the polarity of the gray level signals of the plurality of second pixels P22 in the second row is negative, and so on. According to the above arrangement, the parasitic capacitance effects of pixels will be reduced.

However, in order to switch the polarity of the gray level signals of the pixels, the display voltage provided by the data driver 120 of the prior art needs to be switched alternately between a positive potential and a negative potential, so as to generate a voltage difference between the display voltage and the DC common voltage. Therefore, the data driver 120 needs to comprise a switch circuit to change the polarity of the display voltage. Such arrangement further increases the complexity for circuit design, and has more power consumption.

### SUMMARY OF THE INVENTION

The present invention provides a method for driving a display panel. The display panel comprises a plurality of pixels arranged in a matrix form, a plurality of data lines for providing voltages to the pixels where two adjacent pixels are electrically connected to a same data line, a plurality of scan lines for controlling on and off of the plurality of pixels, and a common voltage supply circuit for providing a common voltage to a common electrode of the pixels. The method comprises in a first time slot of a first polarity inversion period turning on a plurality of first pixels in a first row via a first scan line of the plurality of scan lines, and the common voltage supply circuit providing the common voltage with a first potential; in a second time slot of the first polarity inversion period turning on a plurality of second pixels in the first row via a second scan line of the plurality of scan lines, and the common voltage supply circuit providing the common voltage with a second potential different from the first potential; in a third time slot of the first polarity inversion period turning on a plurality of first pixels in a second row via a third scan line of the plurality of scan lines, and the common voltage supply circuit providing the common voltage with the second potential; and in a fourth time slot of the first polarity inversion period turning on a plurality of second pixels in the second row via a fourth scan line of the plurality of scan lines, and the common voltage supply circuit providing the common voltage with the first potential.

The present invention further provides a display device comprising a display panel, a data driver, a scan driver, and a common voltage supply circuit. The display panel comprises a plurality of pixels arranged in a matrix form, a plurality of scan lines, a plurality of data lines, and a common electrode. The plurality of data lines, the plurality of scan lines, and the common electrode are electrically connected to the plurality of pixels, wherein two adjacent pixels are electrically connected to a same data line. The data driver is electrically connected to the plurality of data lines. The scan driver is electrically connected to the plurality of scan lines for turning on a plurality of first pixels in a first row via a first scan line of the plurality of scan lines in a first time slot of a first polarity inversion period, for turning on a plurality of second pixels in the first row via a second scan line of the plurality of scan lines in a second time slot of the first polarity inversion period, for turning on a plurality of first pixels in a second row via a third scan line of the plurality of scan lines in a third time slot of the first polarity inversion period, and for turning on a plurality of second pixels in the second row via a fourth scan line of the plurality of scan lines in a fourth time slot of the first polarity inversion period. The common voltage supply circuit is for providing a common voltage to the common electrode, wherein the common voltage has a first potential in the first time slot of the first polarity inversion period, has a second potential different from the first potential in the second time slot of the first polarity inversion period, has the second potential in the third time slot of the first polarity inversion period, and has the first potential in the fourth time slot of the first polarity inversion period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a display device of the prior art.

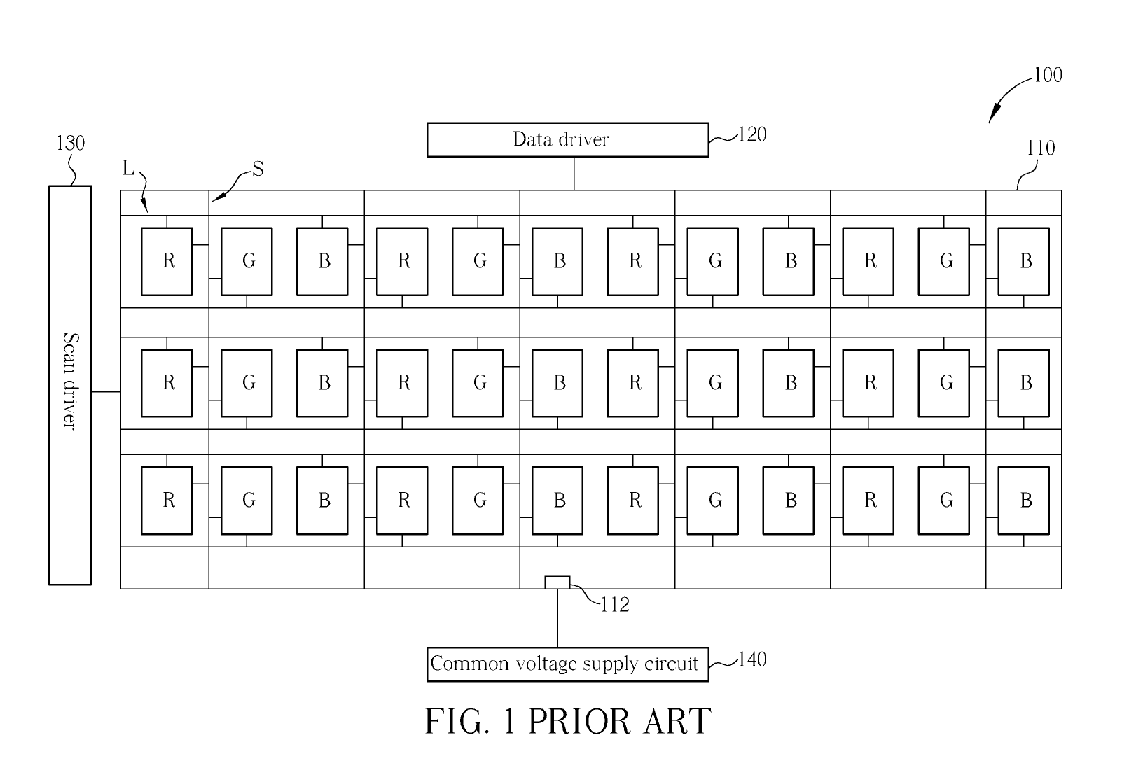

FIG. 2 is a diagram showing a polarity inversion mode of a display panel of FIG. 1.

FIG. 3 is a diagram showing a pixel-driving structure of the display panel of FIG. 1.

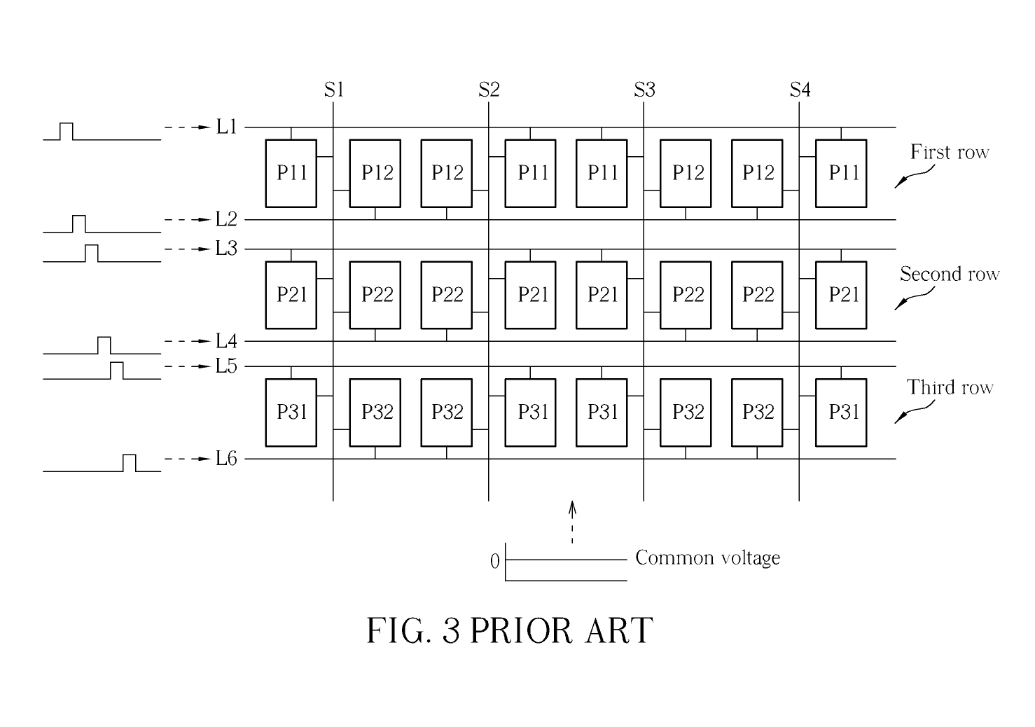

FIG. 4 is a diagram showing related signals of the display panel of FIG. 1.

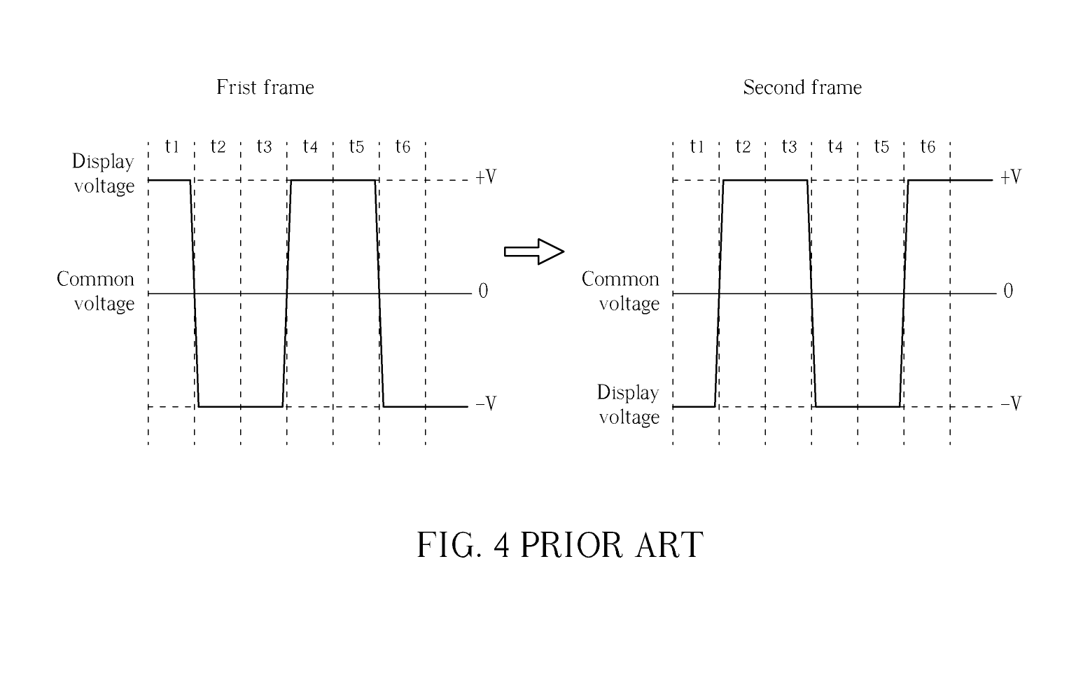

FIG. 5 is a diagram showing a display device of the present invention.

FIG. 6 is a diagram showing a pixel-driving structure of a display panel of FIG. 5.

FIG. 7 is a diagram showing related signals of the display panel of FIG. 5.

FIG. 8 is a diagram showing another display device of the present invention.

### DETAILED DESCRIPTION

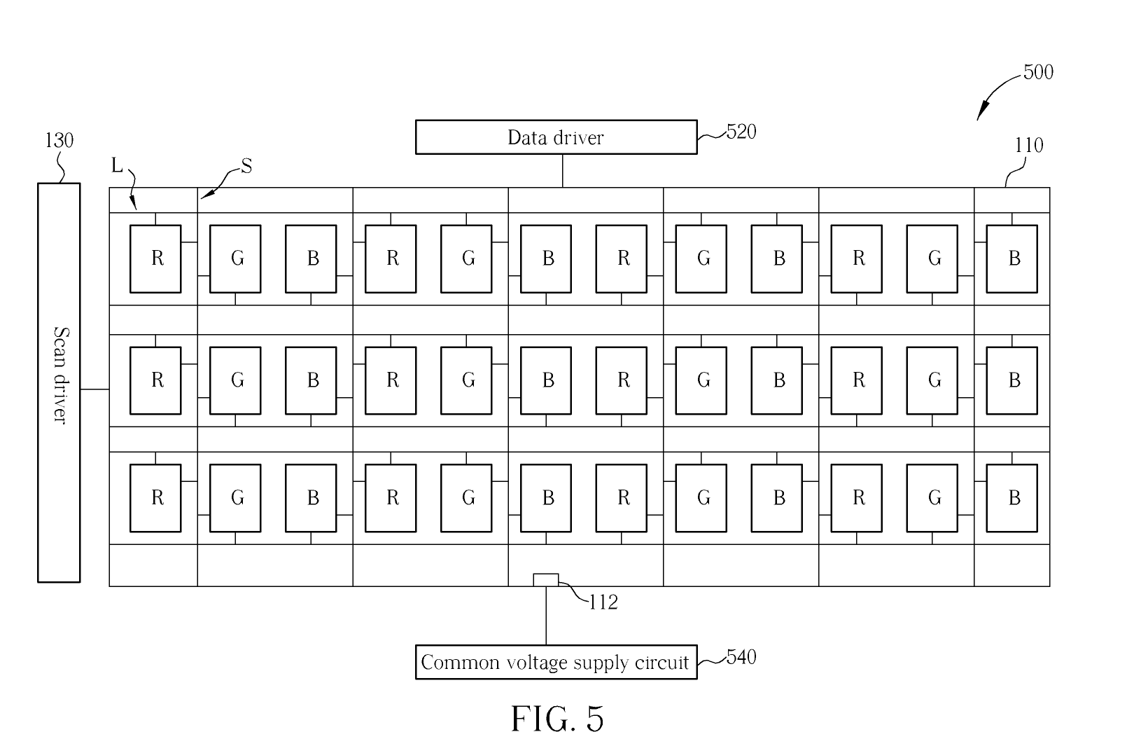

Please refer to FIG. 5. FIG. 5 is a diagram showing a display device 500 of the present invention. The display device 500 of the present invention comprises a display panel 110, a data driver 520, a scan driver 130, and a common voltage supply circuit 540. The display panel 110 comprises a plurality of pixels R, G, B arranged in a matrix form, a plurality of scan lines L, a plurality of data lines S, and a common electrode 112. The plurality of data lines S, the plurality of scan lines L, and the common electrode 112 are electrically connected to the plurality of pixels R, G, B, wherein two adjacent pixels are electrically connected to a same data line S. The data driver 520 is electrically connected to the plurality of data lines S for providing display voltages to the plurality of pixels R, G, B. The scan driver 130 is electrically connected to the plurality of scan lines L for turning on the pixels R, G, B in sequence via the scan line L. The common voltage supply circuit 540 is for providing a common voltage to the common electrode 112. A gray level of each of the pixels R, G, B is determined by a difference between the display voltage and the common voltage.

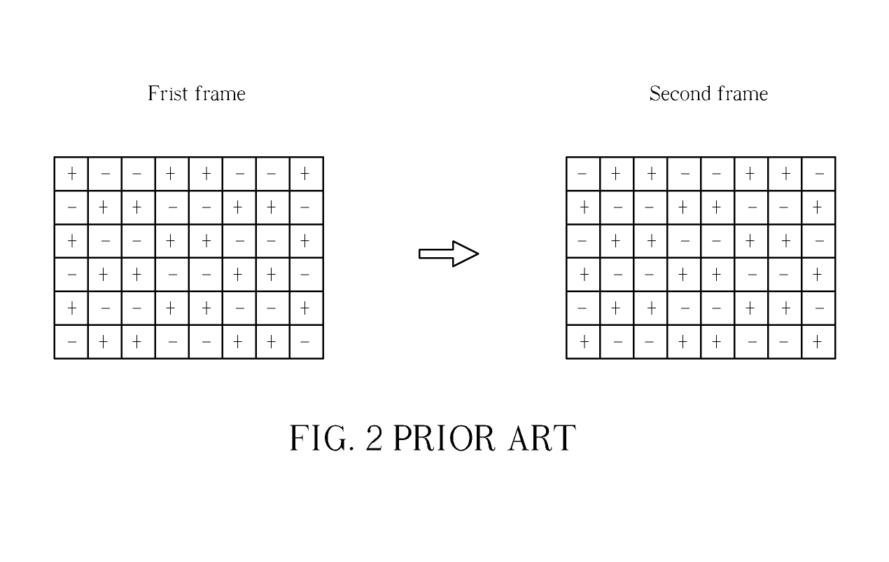

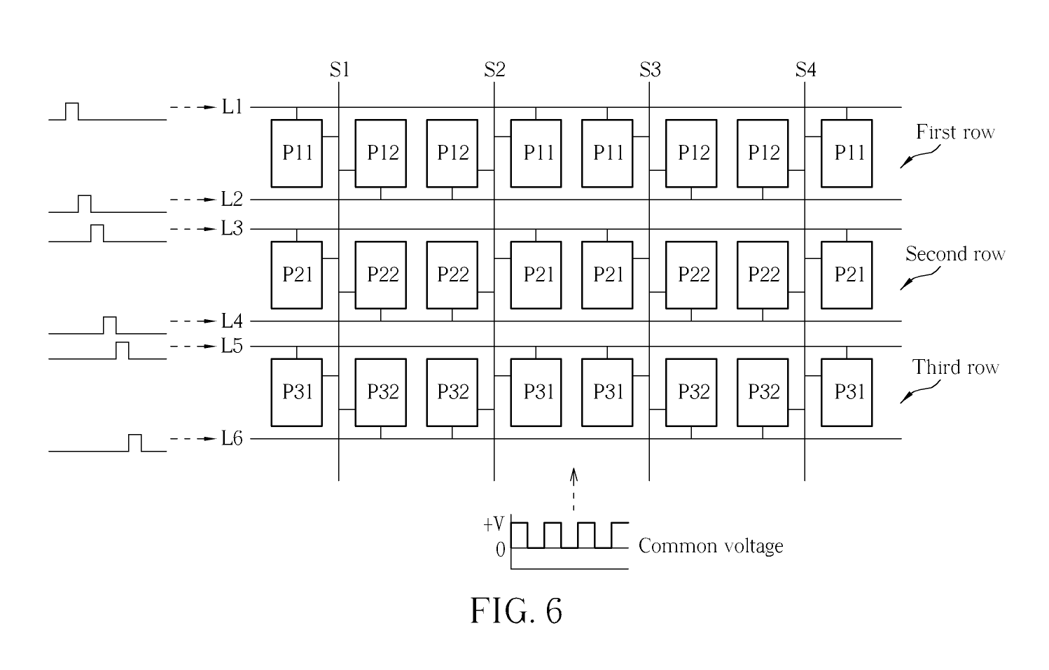

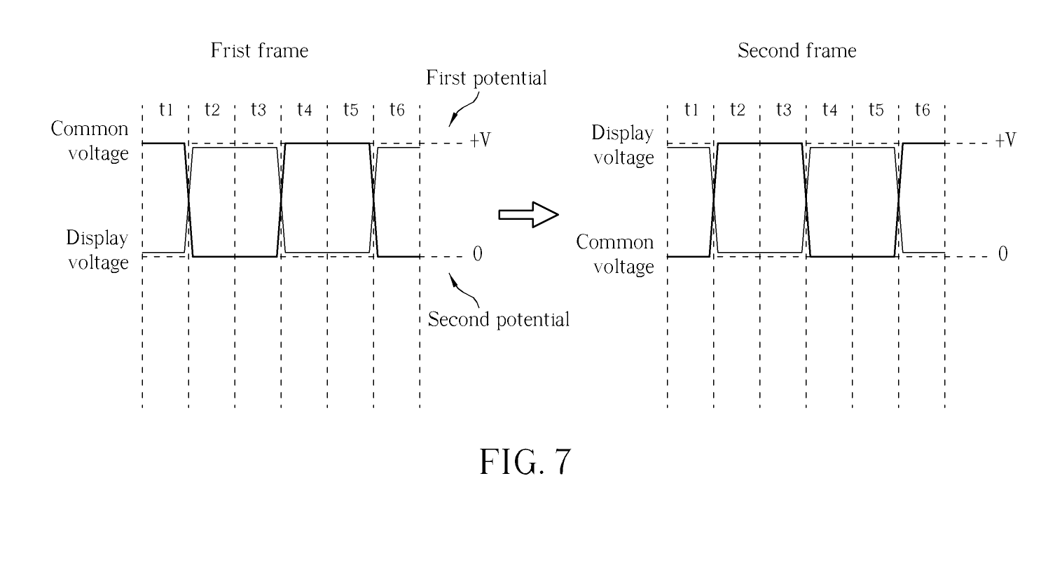

Different from the prior art, both the display voltage provided by the data driver 520 and the common voltage provided by the common voltage supply circuit 540 vary within an interval between a zero potential and a positive potential (or within an interval between a zero potential and a negative potential). Therefore, the data driver 520 does not need to comprise a switch circuit to change the polarity of the display voltage. Please refer to FIG. 6 and FIG. 7. FIG. 6 is a diagram showing a pixel-driving structure of a display panel of FIG. 5. FIG. 7 is a diagram showing related signals of the display panel of FIG. 5. As shown in the figures, in order to drive the display panel in the polarity inversion mode of FIG. 2, when displaying a first frame (or in a first polarity inversion period), the scan driver 130 sequentially turns on a plurality of first pixels P11 in a first row via a first scan line L1 in a first time slot t1, turns on a plurality of second pixels P12 in the first row via a second scan line L2 in a second time slot t2, turns on a plurality of first pixels P21 in a second row via a third scan line L3 in a third time slot t3, turns on a plurality of second pixels P22 in the second row via a fourth scan line L4 in a fourth time slot t4, and so on. The common supply circuit 540 provides the common voltage with a first potential when the plurality of first pixels P11 in the first row are turned on, provides the common voltage with a second potential when the plurality of second pixels P12 in the first row are turned on, provides the common voltage with the second potential when the plurality of first pixels P21 in the second row are turned on, provides the common voltage with the first potential when the plurality of second pixels P22 in the second row is turned on, and so on.

When displaying a second frame (or in a second polarity inversion period), the scan driver 130 sequentially turns on the plurality of first pixels P11 in the first row via the first scan line L1 in the first time slot t1, turns on the plurality of second pixels P12 in the first row via the second scan line L2 in the second time slot t2, turns on the plurality of first pixels P21 in the second row via the third scan line L3 in the third time slot t3, turns on the plurality of second pixels P22 in the second row via the fourth scan line L4 in the fourth time slot t4, and so on. The common supply circuit 540 provides the common voltage with the second potential when the plurality of first pixels P11 in the first row are turned on, provides the common voltage with the first potential when the plurality of second pixels P12 in the first row are turned on, provides the common voltage with the first potential when the plurality of first pixels P21 in the second row are turned on, provides the common voltage with the second potential when the plurality of second pixels P22 in the second row are turned on, and so on. The first potential V is different from the second potential 0 (if both the display voltage and the common voltage vary within the interval between the zero potential and the negative potential, the first potential is −V and the second potential is 0). The display voltage provided by the data driver 520 is between the first potential and the second potential in order to generate a voltage difference with the common voltage.

According to the above arrangement, the data driver 520 does not need to change the polarity of the display voltage in order to switch the polarity of the gray level signals of the pixels. Furthermore, a variation range of the display voltage provided by the data driver 520 is half that of the data driver 120 of the prior art. Since the power consumption of a CMOS circuit is proportional to the square of the voltage, the data driver 520 of the present invention has better power consumption performance than the data driver 120 of the prior art.

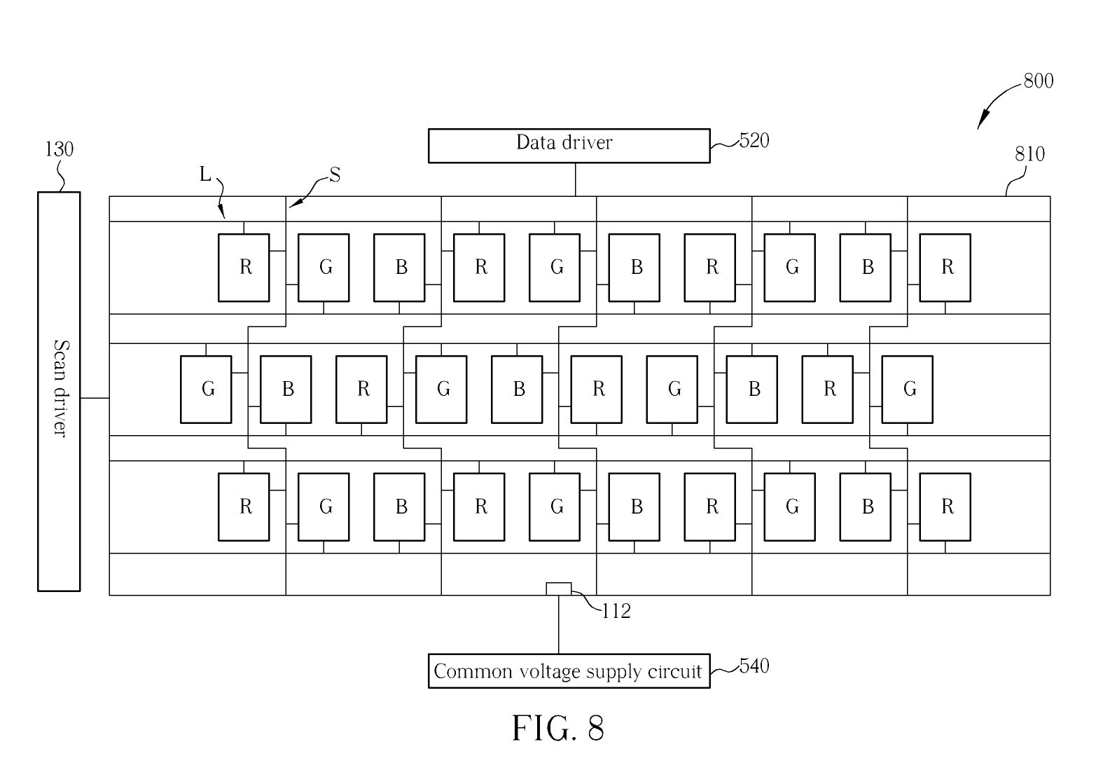

In addition, the arrangement of a column of the pixels of the above display panel is in a stripe form. However, the pixel arrangement of the display panel of the present invention can be in other forms. For example, the arrangement of a column of the pixels of the present invention can be in a triangle form as shown in FIG. 8.

In contrast to the prior art, the display device of the present invention utilizes an AC common voltage to drive the display panel. Therefore, the data driver of the present invention does not need to change the polarity of the display voltage, which further decreases the complexity for circuit design and reduces the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a display panel, the display panel comprising a plurality of pixels arranged in a matrix form, a plurality of data lines for providing voltages to the pixels, wherein two adjacent pixels are electrically connected to a same data line, a plurality of scan lines for controlling on and off of the plurality of pixels, and a common voltage supply circuit for providing a common voltage to a common electrode of the pixels, the method comprising:
in a first time slot of a first polarity inversion period, turning on a plurality of first pixels in a first row via a first scan line of the plurality of scan lines, and the common voltage supply circuit providing the common voltage with a first potential;
in a second time slot of the first polarity inversion period, turning on a plurality of second pixels in the first row via a second scan line of the plurality of scan lines, and the common voltage supply circuit providing the common voltage with a second potential different from the first potential;
in a third time slot of the first polarity inversion period, turning on a plurality of first pixels in a second row via a third scan line of the plurality of scan lines, and the common voltage supply circuit providing the common voltage with the second potential; and
in a fourth time slot of the first polarity inversion period, turning on a plurality of second pixels in the second row via a fourth scan line of the plurality of scan lines, and the common voltage supply circuit providing the common voltage with the first potential.

2. The method of claim 1 further comprising:
in a first time slot of a second polarity inversion period following the first polarity inversion period, turning on the plurality of first pixels in the first row via the first scan line, and the common voltage supply circuit providing the common voltage with the second potential;
in a second time slot of the second polarity inversion period, turning on the plurality of second pixels in the first row, and the common voltage supply circuit providing the common voltage with the first potential;
in a third time slot of the second polarity inversion period, turning on the plurality of first pixels in the second row, and the common voltage supply circuit providing the common voltage with the first potential; and
in a fourth time slot of the second polarity inversion period, turning on the plurality of second pixels in the second row, and the common voltage supply circuit providing the common voltage with the second potential.

3. The method of claim 2, wherein the first polarity inversion period is a period for displaying a first frame, and the second polarity inversion period is a period for displaying a second frame.

4. The method of claim 1, wherein the first potential is a zero potential, a positive potential, or a negative potential.

5. The method of claim 1, wherein the second potential is a zero potential, a positive potential, or a negative potential.

6. The method of claim 1, wherein the first pixel is driven prior to the second pixel.

7. The method of claim 1, wherein the first time slot, the second time slot, the third time slot, and the fourth time slot are time slots for driving pixels in one row.

8. A display device comprising:
a display panel, comprising a plurality of pixels arranged in a matrix form, a plurality of scan lines, a plurality of data lines, and a common electrode, wherein the plurality of data lines, the plurality of scan lines, and the common electrode are electrically connected to the plurality of pixels, and two adjacent pixels are electrically connected to a same data line;
a data driver, electrically connected to the plurality of data lines;
a scan driver, electrically connected to the plurality of scan lines for turning on a plurality of first pixels in a first row via a first scan line of the plurality of scan lines in a first time slot of a first polarity inversion period, for turning on a plurality of second pixels in the first row via a second scan line of the plurality of scan lines in a second time slot of the first polarity inversion period, for turning on a plurality of first pixels in a second row via a third scan line of the plurality of scan lines in a third time slot of the first polarity inversion period, and for turning on a plurality of second pixels in the second row via a fourth scan line of the plurality of scan lines in a fourth time slot of the first polarity inversion period; and
a common voltage supply circuit, for providing a common voltage to the common electrode, wherein the common voltage has a first potential in the first time slot of the first polarity inversion period, has a second potential different from the first potential in the second time slot of the first polarity inversion period, has the second potential in the third time slot of the first polarity inversion period, and has the first potential in the fourth time slot of the first polarity inversion period.

9. The display device of claim 8, wherein the first potential is a zero potential, a positive potential, or a negative potential.

10. The display device of claim 8, wherein the second potential is a zero potential, a positive potential, or a negative potential.

11. The display device of claim 8, wherein arrangement of a column of the pixels is in a stripe form or in a triangle form.
